(19) United States
(12) Patent Application Publication
(10) Pub. No.: US 2024/0182197 A1
(43) Pub. Date: Jun. 6, 2024

(54) ROBOTIC AUTOMATED FILLING AND CAPPING SYSTEM FOR VAPE OIL CARTRIDGES

(71) Applicant: Revessel Inc, Palm Springs, CA (US)

(72) Inventors: Mary Bumatai, Palm Springs, CA (US); Ryan Coats, Menifee, CA (US)

(21) Appl. No.: 18/444,014

(22) Filed: Feb. 16, 2024

Related U.S. Application Data
(63) Continuation of application No. 17/944,880, filed on Sep. 14, 2022, now abandoned.
Application No. 17/944,880 is a continuation of application No. 17/117,069, filed on Dec. 9, 2020, now abandoned.
(60) Provisional application No. 62/945,773, filed on Dec. 9, 2019.

(51) Int. Cl. B65B 43/54; B25J 9/00; B25J 9/16; B65B 3/10; B65B 3/12; B65B 3/28; B65B 7/28; B65B 43/46; B65B 43/56; B65B 55/02; B65B 55/08; B65B 57/04

(52) U.S. Cl. CPC B65B 43/54; B25J 9/1664; B65B 3/10; B65B 3/12; B65B 3/28; B65B 7/28; B65B 43/46; B65B 43/56; B65B 55/02; B65B 55/08; B25J 9/0084; B65B 57/04; G05B 2219/40584

(57) ABSTRACT

A robotic automated filling and capping system is made up of a cartridge infeed conveyor, a cap infeed conveyor, an outfeed conveyor, a six-axis robot, and a selective compliance articulated robot arm, all of which are configured to work together to automatically, and sanitarily, fill and cap vape oil cartridges.

### CROSS-REFERENCE TO RELATED APPLICATIONS

This application is a continuation of U.S. patent application Ser. No. 17/944,880 filed on Sep. 14, 2022, which is a continuation of U.S. patent application Ser. No. 17/117,069 filed on Dec. 9, 2020, which claims the benefit of U.S. Provisional Application No. 62/945,773, filed on Dec. 9, 2019, the teachings of all of which are expressly incorporated by reference.

### STATEMENT RE: FEDERALLY SPONSORED RESEARCH/DEVELOPMENT

Not Applicable

### BACKGROUND

The present disclosure relates generally to robotic automated manufacturing technologies, particularly systems and methods for filling fluid containers, and more particularly to a mobile fully autonomous filling, dosing, capping, and sanitizing system for vape oil cartridges, disposables, and reservoirs.

There are numerous systems in the prior art for automatically filling containers in various manufacturing sectors. These include bottling sodas and milk, filling ink cartridges, and even filling cartridges with explosives. These filling procedures may be automated and are well known.

In general, current practices for filling and capping vape oil cartridges are performed either by hand fill or partial hard automation. With the filling being done by hand, human error often leads to variations in the fill amount. The amount of liquid dispensed into a cartridge measured through the suction apparatuses used cannot be accurately measured unless performed in a separate procedure. Additionally, the temperature of the liquid must remain consistent to provide an accurate amount of dispensing. The parameters involved to complete a filling process with accuracy and speed can only be done through repetitive consistent motion.

Further, these practices are at risk for contamination and cartridge failure due to human error and/or partial hard automation systems only doing partial procedures. Vape cartridges must remain sanitized throughout the filling process. Manufacturing facilities must possess a completely sterile environment to ensure the safety of the product. Additionally, the method for manually capping cartridges can result in a lack of a complete seal around the cartridge. A specific amount of pressure is required to sufficiently seal cartridges to remain spill-proof.

There is nothing currently available to deliver accurate, high-speed filling and capping of vape hardware, along with pre-fill sanitation. Indeed, the industry standard of hand fill or partially hard automated filling systems is messy, wasteful, labor intense, leak prone, and has no sanitation.

As such, there is a need for a system to fully automate vape cartridge filling and capping. The system of the present disclosure eliminates unsanitary human contact by hand filling and other inefficient procedures. These inefficient procedures of the prior art often result in failures, product loss, and sickness. Additionally, the system of the present disclosure allows for a dramatic improvement in the volume of cartridges capable of being filled and capped per work shift, resulting in substantial growth per category. Further, to alleviate the need to provide a separate clean-room for the filling process, the incorporation of an automated sanitization station within the system will suffice to create a sterile product.

### BRIEF SUMMARY

In accordance with one embodiment of the present disclosure, there is contemplated a robotic automated filling and capping system for autonomously filling and capping vape oil cartridges made up of a cartridge infeed conveyor, a cap infeed conveyor, an outfeed conveyor, a six-axis articulated robot, and a Selective Compliance Articulated Robot Arm.

The components of the system all interact to allow for a fully automated fill and cap procedure for vape oil cartridges, resulting in a significantly more efficient and sanitary process for preparing vape oil cartridges. While it is envisioned that the system is utilized for vape oil cartridges, it could also be used for various other liquid filling needs.

In one embodiment, the robotic automated filling and capping system includes a cartridge infeed conveyor configured to accommodate at least one tray of cartridges, a cap infeed conveyor configured to accommodate at least one tray of caps, and an outfeed conveyor configured to accommodate at least one tray of cartridges. The system further includes a filling mechanism configured to dispense a liquid into a cartridge, a six-axis robot disposed in proximity to the cartridge infeed conveyor and the cap infeed conveyor, wherein the six-axis robot is capable of grabbing and moving a tray of cartridges from the cartridge infeed conveyor to the filling mechanism and to the outfeed conveyor, and a selective compliance articulated robot arm disposed in proximity to the outfeed conveyor, wherein the selective compliance articulated robot arm is capable of grabbing a cap from a tray of caps, placing the cap onto a cartridge disposed in a tray of cartridges, and sealing the cap to the cartridge. The system also includes a program logic controller, wherein the program logic controller is in electronic communication with all of the parts of the robotic automated filling and capping system.

The robotic automated filling and capping system may further include a first sensor disposed along the cartridge infeed conveyor, a second sensor disposed along the cap infeed conveyor, and a third sensor disposed along the outfeed conveyor.

Additionally, the six-axis robot may further include a first vision system, and the selective compliance articulated robot arm may further include a second vision system.

In some embodiments, the robotic automated filling and capping system may include at least one UV source. In particular, the robotic automated filling and capping system may include three UV sources in some embodiments. For example, the system may include a first UV source disposed over the cartridge infeed conveyor, a second UV source disposed over the cap infeed conveyor, and a third UV source disposed over the outfeed conveyor.

The robotic automated filling and capping system may further include a scale. Also, the filling mechanism may further include a heated pressure vessel.

In certain embodiments the cartridge infeed conveyor may be configured to accommodate ten trays of cartridges, the cap infeed conveyor may be configured to accommodate ten trays of caps, and the outfeed conveyor may be configured to accommodate ten trays of completed cartridges. In some embodiments, the robotic automated filling and capping system may be in a portable configuration.

In certain embodiments the six-axis robot may further include a tray pan and the selective compliance articulated robot arm may further include a gripping tool having movable jaws and a pneumatically powered sealing cylinder.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective side view of the robotic automated filling and capping system of the present disclosure;

FIG. 2 is a perspective side view of a portion of the robotic automated filling and capping system shown in FIG. 1;

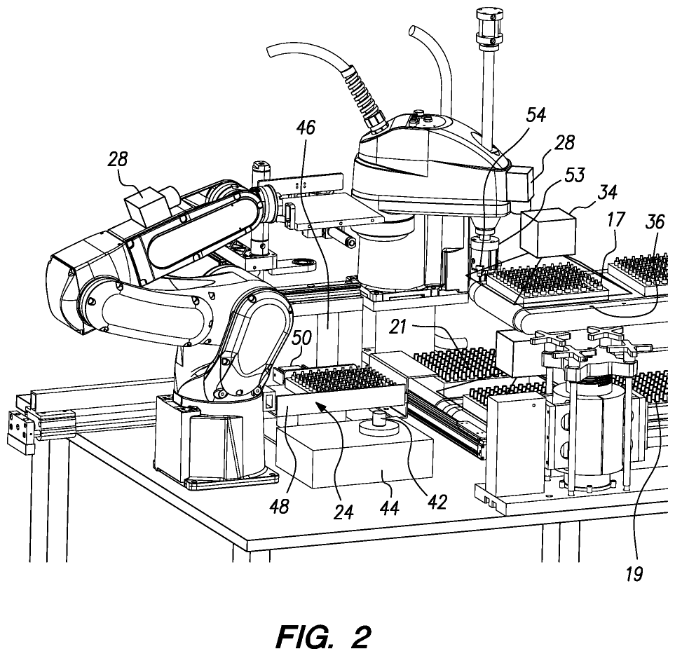

FIG. 3 is a right side view of the robotic automated filling and capping system;

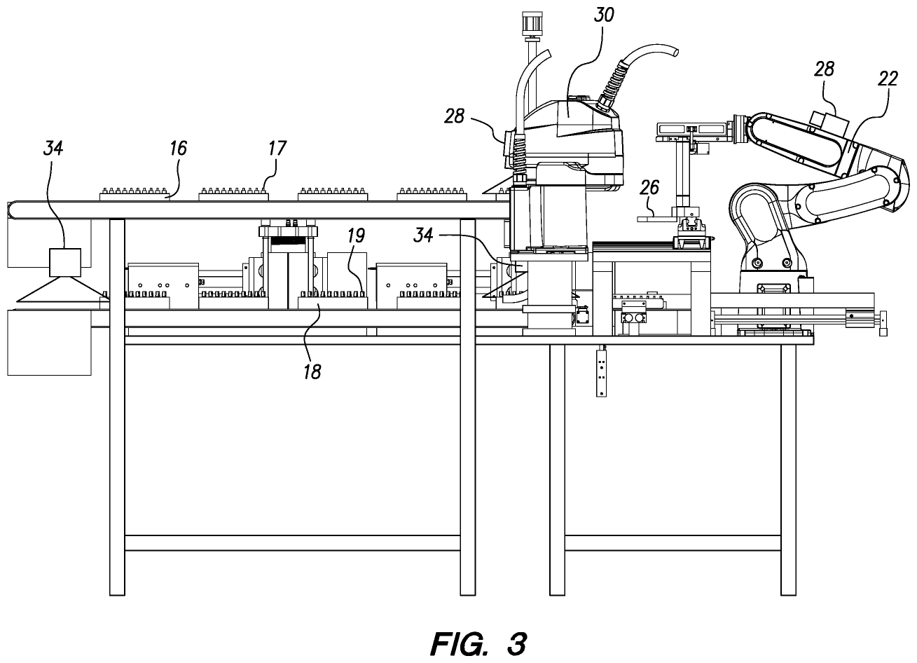

FIG. 4 is a left side view of the robotic automated filling and capping system;

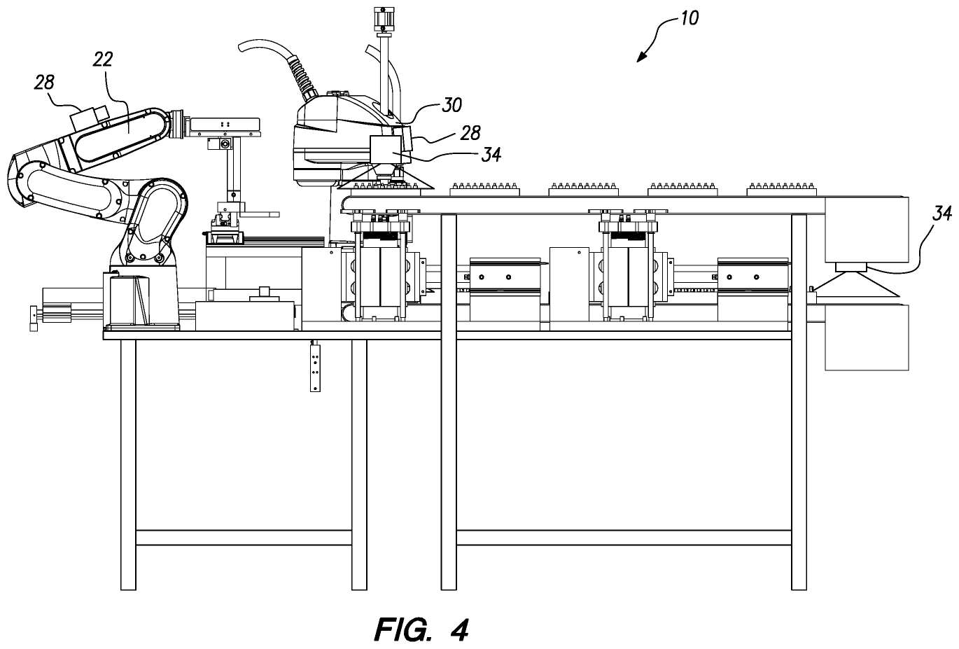

FIG. 5 is a perspective side view of the filling portion of the robotic automated filling and capping system;

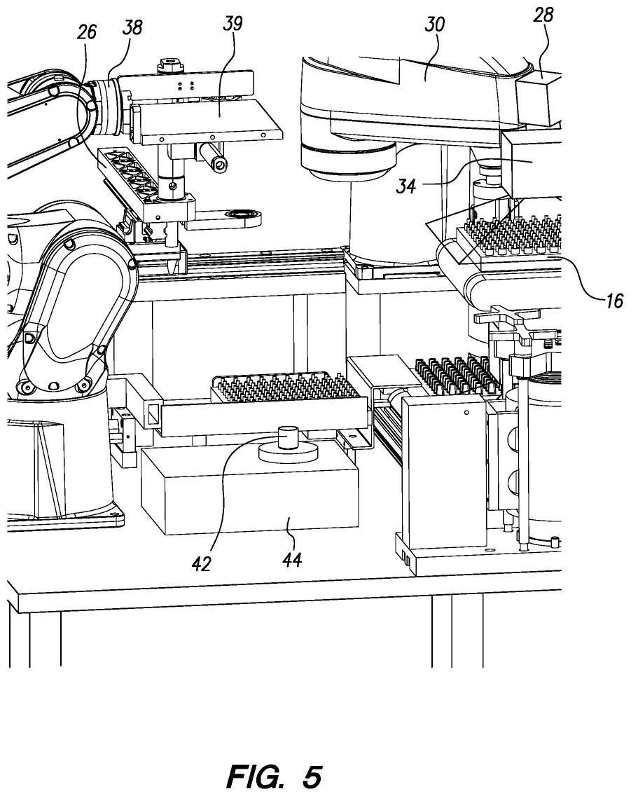

FIG. 6 is a rear perspective view of the robotic automated filling and capping system;

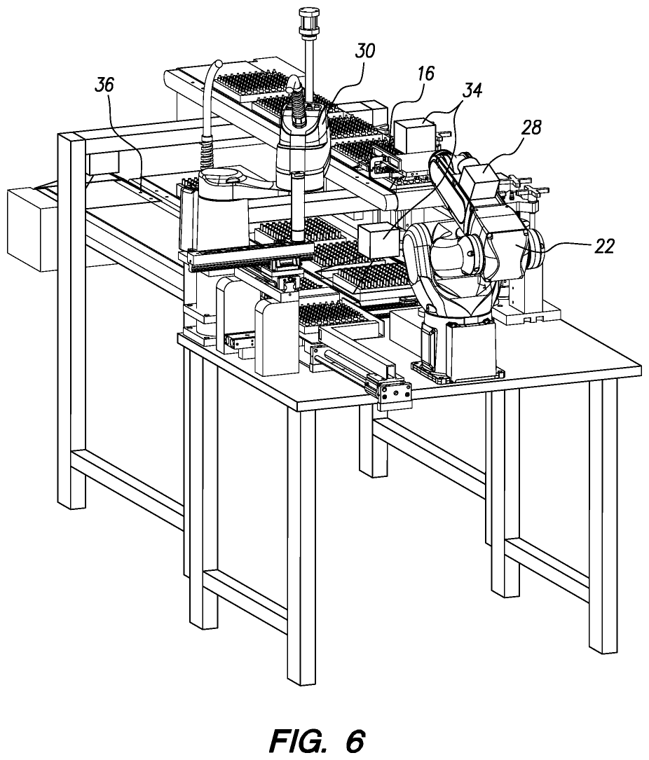

FIG. 7 is a top view of the robotic automated filling and capping system;

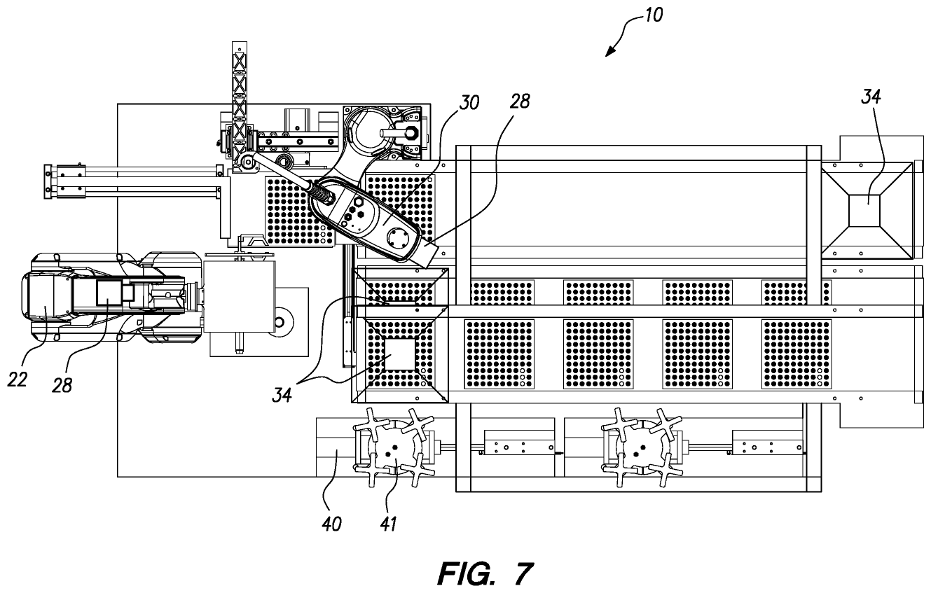

FIG. 8 is a side perspective view of the robotic automated filling and capping system;

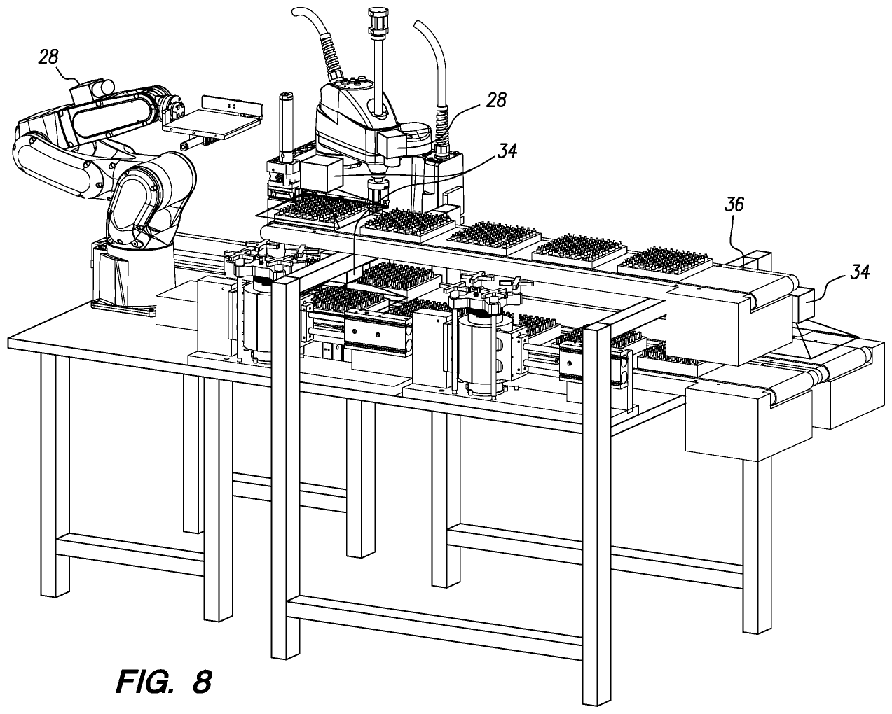

FIG. 9 is a top perspective view of the robotic automated filling and capping system; and

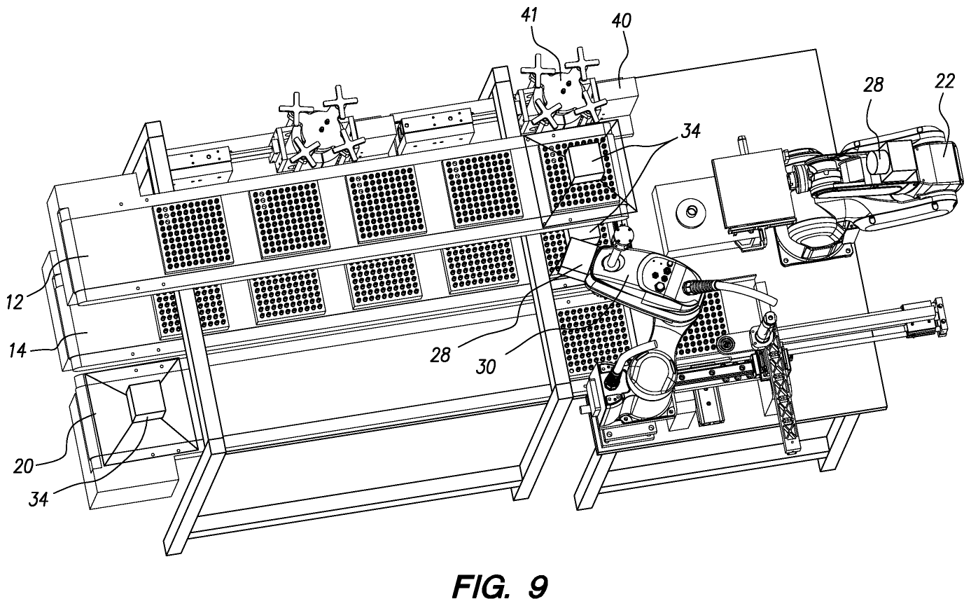

FIG. 10 is perspective side view of the robotic automated filling and capping system in an enclosed portable embodiment.

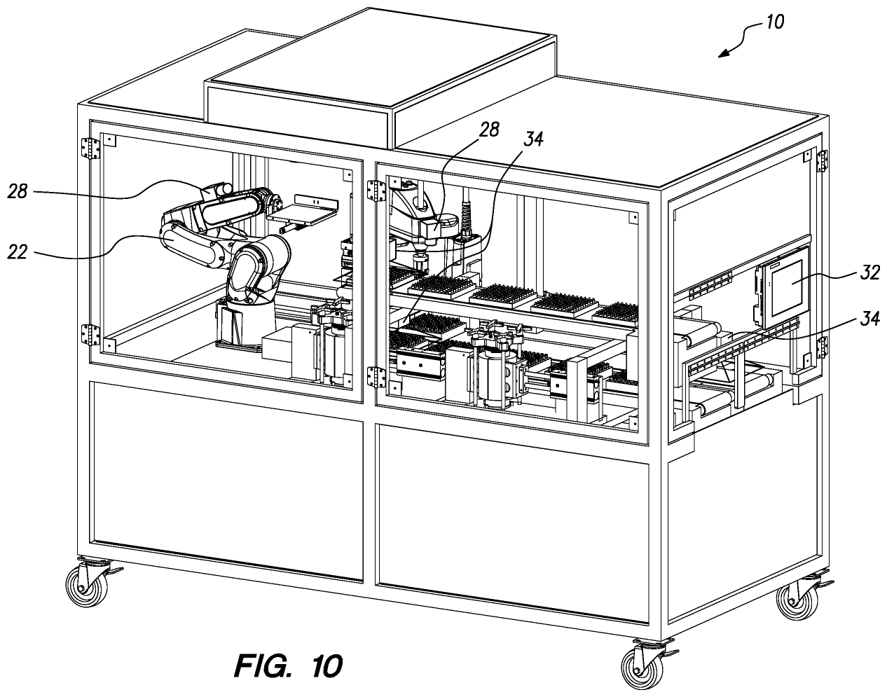

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

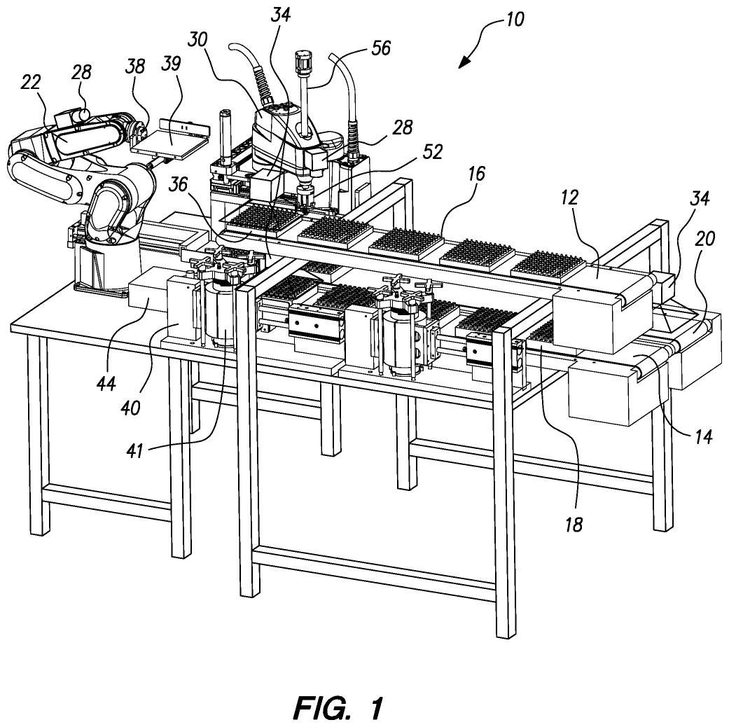

As shown in the figures, and best seen in FIG. 1, there is disclosed and shown a robotic automated filling and capping system 10. The system includes two infeed conveyors, namely, a cartridge infeed conveyor 12 and a cap infeed conveyer 14. The cartridge infeed conveyor 12 will be loaded with at least one cartridge tray 16 for processing by the system 10. While any number of trays 16 and configurations of cartridges 17 in the trays may be utilized, it is envisioned that the system 10 may allow for the loading of ten cartridge trays 16 in succession, with each cartridge tray 16 containing one hundred cartridges 17. Additionally, the cap infeed conveyor 14 will also be loaded with at least one cap tray 18 for processing by the system 10. Again, while any number of trays 18 and configurations of caps 19 in the trays 18 may be utilized, it is envisioned that the system 10 may allow for the loading of ten cap trays 18 in succession, with each cap tray 18 containing one hundred caps 19.

The system 10 further includes an outfeed conveyor 20 for moving filled and capped cartridges out of the system 10. A program logic controller (PLC) 32 will orchestrate the entire system 10 and process, allowing parts to move, lock, and perform specific tasks. In particular, the PLC 32 will control and drive the conveyors 12, 14, 20. The cartridge trays 16 and the cap trays 18 are driven along the cartridge infeed conveyor 12 and the cap infeed conveyor 14, respectively, until they reach a stopping point indicated by a sensor 36 in communication with the PLC 32. The cap tray 18, once it reaches its stopping point indicated by the sensor 36, will remain stationary at the end of the cap infeed conveyor 14 until pneumatically driven to the outfeed conveyor 20.

While empty cartridges 17, caps 19, or completed cartridges 21, are moving on the conveyors 12, 14, 20 they may be covered in ultraviolet light by at least one UV source 34 to disinfect the parts. In some embodiments, the conveyors 12, 14, 20 may comprise translucent belts in order to allow the UV light to radiate on the parts from all directions, including the bottom. The UV source 34 may be high performing LEDs that operate in the 230 nm to 280 nm range. These UV sources 34 may be mounted along the cartridge infeed conveyer 12, cap infeed conveyor 14, and/or the outfeed conveyer 20. The UV sources 34 serve to disinfect, sterilize, and eliminate microorganisms within its reach.

The system 10 also includes a six-axis robot 22 disposed such that it can reach the cartridge trays 16 and the cap trays 18, as they come in from their conveyors 12, 14, and a capping station 24 disposed near the outfeed conveyor 20. The six-axis robot 22 may be configured to pick the cartridge tray 16 from the cartridge infeed conveyor 12 and move the cartridge tray 16 to a cartridge press plate 26. The cartridge press plate 26 may ensure that all cartridges 17 within the cartridge tray 16 are the same height before filling and capping. The six-axis robot 22 may then utilize its vision system 28 to capture a four-quadrant photographic image of the cartridge tray 16 to create offset locations for each part to be filled. The six-axis robot 22 may be, for example, a Fanuc® LR-Mate 120iD.

When the cartridge tray 16 reaches its stopping point as indicated by the sensor 36, the six-axis robot 22 will grab the cartridge tray 16 with its end of arm tool 38. The end of arm tool 38 may comprise a tray pan 39 configured to pneumatically retract and expand its grip to mimic the motion of a human hand. The six-axis robot 22 may have the capability of moving up to a speed of 200 mm/s in between points of interest. This speed will assist in completing the goal of automating the cartridge filling procedure at a set time.

The six-axis robot 22 will move the cartridge tray 16 to a filling mechanism 40. The filling mechanism 40 will dispense an appropriate amount of liquid into each individual cartridge 17. The filling mechanism 40 comprises an amplified pressure vessel 41 that will be heated to a specified temperature and allow the liquid to flow. The filling mechanism 40 will minimize frictional forces associated with the liquid's viscosity levels and allow a steady stream of consistent volume to dispense in each cartridge 17.

Before filling the cartridges 17, the filling system 10 may perform a measuring test. This measuring test may be effected by the six-axis robot 22 placing a measuring cup 42 on a scale 44. The scale 44 may be a precision scale capable of recording up to a precision of 0.0001 gram. The six-axis robot 22 will then dispense an amount of fluid into the measuring cup 42, the weight of which is relayed by the scale 44 to the PLC 32, so that the PLC can provide accurate fill information to the filling mechanism 40. The six-axis robot 22 will then fill each cartridge 17 in the cartridge tray 16 and set the cartridge tray 16 of filled cartridges on the capping station 24. The six-axis robot 22 will then return to the cartridge infeed conveyor 14 to pick the next tray of empty cartridges 16 and start the process over. The six-axis robot 22 will accurately move the cartridge tray 16 along a column and row pattern, traversing along each axis. The six-axis robot 22 will meet a tip of the filling mechanism 40 to the inside edge of each cartridge 17 and allow dispensing of the predefined volume of liquid. This procedure will repeat as often as needed until all cartridges 17 in the cartridge tray 16 are filled. This repetitive task will ensure consistency throughout the process, allowing an equal amount of liquid to be dispensed in each cartridge.

Disposed next to the capping station 24 is a Selective Compliance Articulated Robot Arm (SCARA) 30. The SCARA 30 is configured to detect the presence of a filled cartridge tray 16 in the capping station 24, at which point the SCARA 30 will use its vision system 28 to check the location of a cap tray 18 and the location of the filled cartridge tray 16. The cap tray 18 may be pneumatically held against an upright 46 for rigid support. The cap tray 18 thus remains in a stationary position awaiting removal of caps 19. The cartridge tray 16 is thus disposed in a flanged pan 48 that holds the cartridge tray 16. Pneumatic cylinders 50 may push along both sides of the cartridge tray 16 tray to evenly distribute force across the cartridge tray 16. The cylinders 50 are compresses via communication between the six-way robot 22 and the PLC 32. Thus, the cartridge tray 16 is stationary and awaiting placement of caps 19.

The SCARA 30 then picks up and pre-presses caps 19 from the cap tray 18 onto filled cartridges 17 in the cartridge tray 16 until all are on. The SCARA 30 has an end of arm tool 52 configured to interact with the caps 19. In particular, a small pneumatic gripping tool 53 will allow jaws 54 to open and close while forming the shape of, and retaining, the cap 19 at its closed position. The SCARA 30 will travel in a row and column motion traversing each axis until a cap 19 is placed on each cartridge 17. After that, the SCARA's end of arm tooling (EOAT) 52 will utilize a pneumatic sealing cylinder 56 that it positions over each pre-capped cartridge 17 and will press with a calibrated pressure to permanently seal the cartridges 17 with the caps 19. The SCARA 30 checks throughout this process for over travel or crushed parts. Once the capping is completed, the SCARA 30 moves out of the way, and the cartridge tray 16 containing filled and capped cartridges 21 is moved onto the outfeed conveyor 20 to be packaged by the end user. The SCARA 30 may be, for example a Fanuc® SR3iA. Both the six-axis robot 22 and the SCARA 30 are in communication with each other, and the rest of the system 10, by way of the PLC 32.

At this point, one complete cycle has been performed, and the cap tray 18 will be released from its compressed position. The outfeed conveyor 20 will transfer the empty cap tray 18 along with the cartridge tray 16 containing completed (filled and capped) cartridges 21 until reaching a stop point indicated by a sensor 36, at which point the trays can be removed by an operator of the system 10.

The entire system 10 will communicate between its various components to indicate when and where parts are at any specific time. Further, the robots 22, 30 are continuously communicating with each other (for example, by way of direct Ethernet-IP wiring to each other) and the entire system via direct wiring to the PLC 32, so that inputs and outputs may be monitored and controlled by the system 10. To implement a consistent location of each cartridge 17 and cap 19 within their respective trays 16, 18, vision systems 28 will be utilized to repetitively capture visual images of the center location for each cap tray 18 and cartridge tray 16. These locations may be transmitted to the robots 22, 30 via algorithms processed by the PLC to identify each location on the tray. This will simulate a grid map of the cartridges or caps.

While the general characteristics of the system 10 have been described above, it is envisioned that the system may be configured in a mobile fashion for ease of use by the end user. In that regard, the system 10 may be broken into two parts, a feeding system 10a and a filling system 10b. Both the feeding system 10a and filling system 10b may be mobile and run off of standard 120V electricity. Each of the feeding system 10a and the filling system 10b may utilize a standard electrical plug that may be plugged into an outlet at the user's site.

Potential steps for using one embodiment of the system 10 are described more fully below. As discussed, the feeding system 10a and the filling system 10b may be mobile and configured to be rollable or otherwise movable for transportation. The user will move the feeding system 10a and the filling system 10b to an appropriate location at its site. The feeding system 10a and filling system 10b are then latched into position together and plugged into AC at the user's site. Needed air (e.g., 80 psi dry air) is provided to the system 10 either by attaching shop air from the user's site to the system 10, or the system may be configured with an onboard compressor for sites without access to shop air.

Once located in the proper position, provided with power, and provided with air, the system 10 is turned on and the user will load cartridge trays 16 onto the cartridge infeed conveyor 12 and cap trays 18 onto the cap infeed conveyor 14. A vessel 41 containing the liquid to be filled into the cartridges 17 will be loaded into the heating/filling mechanism 40 of the system 10.

At this point, the user will program the system 10 with the fill/dose amount per cartridge 17 and the quantity of cartridges 17 to run and then start the program. The system 10 will automatically run a start program to load the filling lines of the system 10 and measure the output. If the desired output is off, the system 10 will automatically adjust to the desired amount and begin filling and capping the cartridges 17.

After the internal process is complete for each tray 16, the system will check the calibration of the filling system 10b and, if it is accurate, it will move the completed tray 16 out onto the outfeed conveyor 20. However, if the fill/dose fails, the system 10 will trigger an alarm and stop the program for user intervention.

The above description is given by way of example, and not limitation. Given the above disclosure, one skilled in the art could devise variations that are within the scope and spirit of the invention disclosed herein, including various additional and optional components such as, unique robotic and motion programming, linear tow system for high pressure capping and crush detection, UV lights for disinfecting parts, RF energy for heating the dispensed product, pyrometer and PID loop temperature control for constant viscosity adjustment, onboard air systems, closed looped fill/dose system, and the like. Additionally, while described above to be utilized for filling vape oil cartridges, it is envisioned that the present system could be used in various industries and settings for filling liquids into containers for various purposes. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A robotic automated filling and capping system comprising:
a cartridge infeed conveyor configured to accommodate at least one tray of cartridges;
a cap infeed conveyor configured to accommodate at least one tray of caps;
an outfeed conveyor configured to accommodate at least one tray of cartridges;
a filling mechanism configured to dispense a liquid into a cartridge;
a six-axis robot disposed in proximity to the cartridge infeed conveyor and the cap infeed conveyor, wherein the six-axis robot is capable of grabbing and moving a tray of cartridges from the cartridge infeed conveyor to the filling mechanism and to the outfeed conveyor;
a selective compliance articulated robot arm disposed in proximity to the outfeed conveyor, wherein the selective compliance articulated robot arm is capable of grabbing a cap from a tray of caps, placing the cap onto a cartridge disposed in a tray of cartridges, and sealing the cap to the cartridge; and
a program logic controller, wherein the program logic controller is in electronic communication with all of the parts of the robotic automated filling and capping system.

2. The robotic automated filling and capping system of claim 1, further comprising a first sensor disposed along the cartridge infeed conveyor, a second sensor disposed along the cap infeed conveyor, and a third sensor disposed along the outfeed conveyor.

3. The robotic automated filling and capping system of claim 1, wherein the six-axis robot further comprises a first vision system, and the selective compliance articulated robot arm further comprises a second vision system.

4. The robotic automated filling and capping system of claim 1, further comprising at least one UV source.

5. The robotic automated filling and capping system of claim 4, comprising three UV sources.

6. The robotic automated filling and capping system of claim 5, wherein a first UV source is disposed over the cartridge infeed conveyor, a second UV source is disposed over the cap infeed conveyor, and a third UV source is disposed over the outfeed conveyor.

7. The robotic automated filling and capping system of claim 1, further comprising a scale.

8. The robotic automated filling and capping system of claim 1, wherein the filling mechanism further includes a heated pressure vessel.

9. The robotic automated filling and capping system of claim 1, wherein the cartridge infeed conveyor is configured to accommodate ten trays of cartridges, the cap infeed conveyor is configured to accommodate ten trays of caps, and the outfeed conveyor is configured to accommodate ten trays of completed cartridges.

10. The robotic automated filling and capping system of claim 1, wherein the six-axis robot further comprises a tray pan.

11. The robotic automated filling and capping system of claim 1, wherein the selective compliance articulated robot arm further comprises a gripping tool having movable jaws and a pneumatically powered sealing cylinder.

12. The robotic automated filling and capping system of claim 1, wherein the system is configured to be portable.
